(19) United States
(12) Patent Application Publication
(10) Pub. No.: US 2004/0221839 A1
(43) Pub. Date: Nov. 11, 2004

(54) Illumination apparatus for an extractor hood

(75) Inventors: Manfred Plankl, Traunreut (DE); Christoph Schmitt, Stein An Der Traun (DE)

Correspondence Address: LERNER AND GREENBERG, PA, P O BOX 2480, HOLLYWOOD, FL, 33022-2480, US

(73) Assignee: BSH Bosch und Siemens Hausgerate GmbH

(21) Appl. No.: 10/827,631

(22) Filed: Apr. 19, 2004

Related U.S. Application Data
(63) Continuation of application No. PCT/EP02/11417, filed on Oct. 11, 2002.

(30) Foreign Application Priority Data
Oct. 19, 2001 (DE) 101 51 732.7

(51) Int. Cl. F21V 7/00

(52) U.S. Cl. 126/299 D

(57) ABSTRACT

A lighting device for an extractor hood includes a light source having at least a plurality of controlled LEDs and an extractor hood control device. The light source is connected to the control device. The light source can also include halogen and/or incandescent lamps. The control device can vary a luminous intensity of at least some of the LEDs and/or the lamps, alter a diode current of at least some of the LEDs, and/or drive a subset of the LEDs or lamps.

### CROSS-REFERENCE TO RELATED APPLICATION

This application is a continuation, under 35 U.S.C. § 120, of copending international application No. PCT/EP02/11417, filed Oct. 11, 2002, which designated the United States; this application also claims the priority, under 35 U.S.C. § 119, of German patent application No. 101 51 732.7, filed Oct. 19, 2001; the prior applications are herewith incorporated by reference in their entirety.

### BACKGROUND OF THE INVENTION

### FIELD OF THE INVENTION

The present invention relates to an illumination apparatus on an extractor hood having a light source.

German Utility Model DE 87 16 517 U1 discloses an apparatus for producing an air curtain in the region of a physical opening that has a box-like housing. A fan is disposed in the housing for producing the air curtain, and the housing is provided with a suction opening and an exhaust opening. Furthermore, two or more light sources are built into the housing and radiate downward from the housing, the light sources being recessed in the closed, lower wall of the housing. The light sources are each in the form of spot lamps that are built into the housing individually so that they can pivot. In such a case, it is proposed that the light sources are configured as low-volt lamps. Furthermore, fittings, holders, connections, and control elements, such as a dimmer and a transformer, for driving the light sources are disposed in the interior of the housing.

However, one disadvantage in such a case is the fact that the lamps have only a short life and, when they are dimmed, i.e., at a reduced luminous intensity of the light sources, are characterized by a high power consumption.

U.S. Pat. No. 5,690,093 to Schrank et al. discloses an extractor hood that is provided with a push-button keypad and a control circuit coupled thereto. The push-button keypad and the control circuit can be used to set a fan speed and a luminous intensity for a lighting device. It is, thus, possible to operate the lighting device during a working phase at a high illumination level. It is also possible to operate the lighting device at a lower luminous intensity so that the lighting device is, for example, in the form of a night light for a working area or a kitchen area.

Provision is also made for a certain speed and power range for the fan device of the extractor hood and for the selected luminous intensity of the lighting device to be indicated by LEDs that are disposed in the region of the push-button keypad.

### SUMMARY OF THE INVENTION

It is accordingly an object of the invention to provide an illumination apparatus for an extractor hood that overcomes the hereinafore-mentioned disadvantages of the heretofore-known devices of this general type and that has a light source with a long life and low power consumption and has a high degree of efficiency within an illumination level range that can be set.

With the foregoing and other objects in view, in an extractor hood there is provided, in accordance with the invention, an illumination apparatus including a light source including a plurality of drivable LEDs.

In accordance with a further feature of the invention, the light source is formed, according to the invention, from a large number of LEDs—illumination elements, used as the light source, that have a long life and low power consumption or a high efficiency even at a reduced illumination level. A further advantage is the fact that all illumination intensities from full working illumination of the hob disposed below an extractor hood to minimum nighttime illumination and/or emergency illumination can be set in a simple manner and with low power consumption depending on how many LEDs of the multiplicity of LEDs are used or by driving all of the LEDs.

Furthermore, using LEDs as the light source for the illumination apparatus affords the advantage that it is possible to optimize the illumination of a working area beneath an extractor hood in a simple manner by suitably disposing the LEDs, and that, in addition, there is a considerable amount of freedom in the design of the form of the light source and the illumination apparatus.

In accordance with an added feature of the invention, the luminous intensity of the LEDs can be varied in a simple manner using a control device.

In accordance with an additional feature of the invention, it is possible to set the luminous intensity in a simple manner using one advantageous embodiment of the illumination apparatus in which the LEDs can be driven individually by the electrical control device. With such a refinement, it is, advantageously, possible to regulate and control the illumination intensity of the light source by setting the light emission of each individual LED.

In accordance with yet another feature of the invention, the radiated power of the light source is set through the level of the diode current and/or the number of driven LEDs. Such a configuration makes it possible, in particular, for the illumination level of the light source to take place when switching from a high illumination intensity, such as, in particular, during a working phase, to a lower luminous intensity, such as in the case of nighttime or emergency illumination of an extractor hood, for example, in a simple manner by reducing the diode current and/or reducing the number of driven LEDs.

In accordance with yet a further feature of the invention, the light source is a combination of LEDs and lamp(s), the term “lamps” being understood in this context to mean commercially available, conventional luminaires, such as incandescent lamps, halogen lamps, low-volt lamps, etc., for example. When the light source has such a configuration, it is advantageous, in the transition from working illumination to nighttime or emergency illumination of an extractor hood, for the “normal” lamps or luminous elements to be switched off and for the nighttime or emergency illumination only to be provided by the LEDs.

To be able to provide emergency illumination of a working or kitchen area even in the event of a power failure, in accordance with yet an added feature of the invention, the light source is coupled to an energy store that makes available the required energy for the operation of the nighttime or emergency illumination of an extractor hood. In such a case, the energy store may be in the form of a rechargeable battery or a capacitor disposed in the housing of the extractor hood that, for a certain amount of time, makes available the required power for the light source.

In accordance with yet an additional feature of the invention, a control device is connected to the LEDs and the control device detects a failure in the power supply and thereupon operates at least some of the LEDs with the energy store as an emergency light.

With the objects of the invention in view, there is also provided an illumination apparatus for an extractor hood, including an extractor hood control device and an extractor hood light source having a plurality of LEDs, the extractor hood light source being connected to the control device, the control device varying a luminous intensity of at least some of the LEDs.

With the objects of the invention in view, there is also provided an illumination apparatus for an extractor hood, including an extractor hood control device and an extractor hood light source having a plurality of LEDs, the extractor hood light source being connected to the control device, the control device programmed to vary a luminous intensity of at least some of the LEDs, altering a diode current of at least some of the LEDs, and/or drive a subset of the LEDs.

With the objects of the invention in view, there is also provided an illumination apparatus for an extractor hood, including an extractor hood control device, an extractor hood light source connected to the extractor hood control device; and having at least one lamp and a plurality of LEDs, and the control device varying a luminous intensity of at least some of the LEDs.

With the objects of the invention in view, there is also provided an illumination apparatus for an extractor hood, including an extractor hood control device, an extractor hood light source connected to the control device and having at least one lamp and a plurality of LEDs, and the control device programmed to vary a luminous intensity of at least some of the LEDs and the lamp, altering a diode current of at least some of the LEDs, drive a subset of the LEDs and the lamp, and/or independently control the LEDs and the lamp.

Other features that are considered as characteristic for the invention are set forth in the appended claims.

Although the invention is illustrated and described herein as embodied in an illumination apparatus for an extractor hood, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a diagrammatic, perspective view from below an extractor hood having an illumination apparatus according to the invention;

FIG. 2 is a diagrammatic, fragmentary plan view of the illumination apparatus of FIG. 1; and

FIG. 3 is a diagrammatic, fragmentary plan view of a further embodiment of the illumination apparatus of FIG. 1.

### DESCRIPTION OF THE PREFERRED EMBODIMENTS

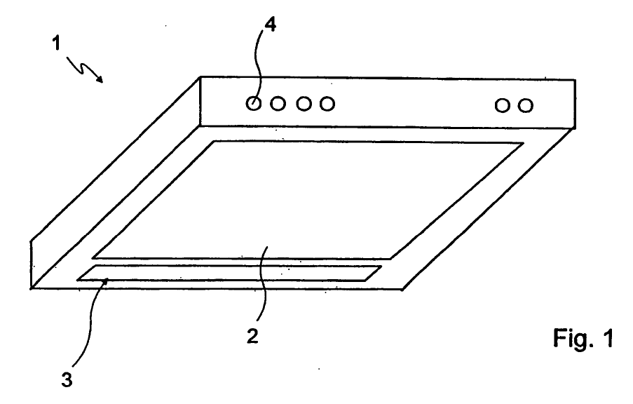

Referring now to the figures of the drawings in detail and first, particularly to FIG. 1 thereof, there is shown a three-dimensional view from below an extractor hood 1, which has an inlet opening 2 and an illumination apparatus 3 underneath. A suction system (not shown in any more detail) and a filter device connected upstream of the suction system are disposed within the extractor hood 1. The suction system and the illumination apparatus 3 can be driven by a person using two or more switches 4 disposed on one end side of the extractor hood 1 such that it is possible to set different power levels for a fan unit of the suction system and different luminous intensities within a luminous intensity range for the illumination apparatus 3.

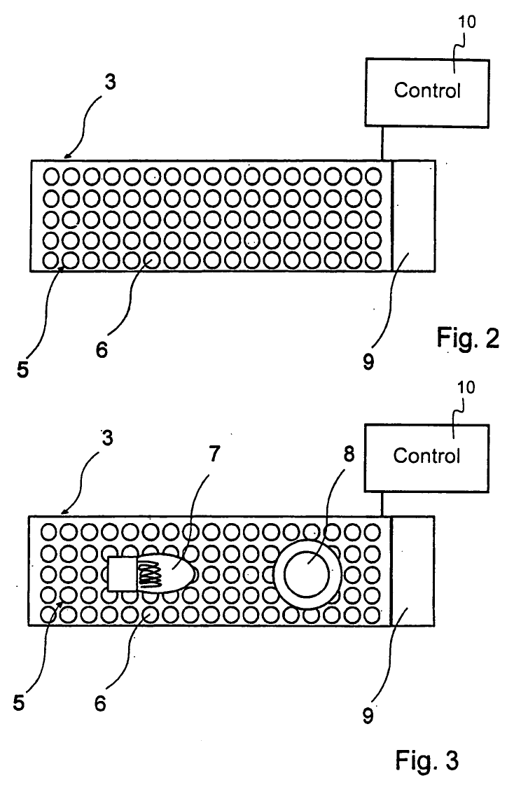

FIG. 2 shows a detail of the illumination apparatus 3 shown in FIG. 1, the illumination apparatus 3 being provided with a light source 5 that is formed by LEDs 6 that can be driven individually and directly using an electrical control device 10. The illumination apparatus 3 is, in such a case, configured so that a radiated power of the light source 5 is set by regulating the diode current and/or the number of driven LEDs 6. This makes it possible to set virtually any illumination level for the light source 5 between a maximum illumination level and a state in which the illumination apparatus 3 is switched off.

The diagram in FIG. 3 shows a further embodiment of the illumination apparatus 3, the light source 5 of the illumination apparatus 3 being formed by a combination of two or more LEDs 6, an incandescent lamp 7, and a halogen lamp 8. In such an embodiment of the illumination apparatus 3, it is possible to vary the illumination level of the light source 5 by driving the incandescent lamp 7, the halogen lamp 8, and all of the LEDs 6 during a “working illumination” mode, in which a high luminous intensity is desired. If a lower luminous intensity for the light source 5 of the illumination apparatus 3 is desired, it is possible to reduce the current level supplied to the light source 5 and to deactivate the incandescent lamp 7, the halogen lamp 8, and/or some of the LEDs one after the other or in any other sequence different therefrom.

If an illumination apparatus 3 shown in FIG. 2 or 3 of the extractor hood 1 is required to provide nighttime illumination or emergency illumination only using the LEDs 6 of the light source 5, either the diode current supplied to the LEDs or the number of driven LEDs 6 is reduced for the purpose of setting a luminous intensity for the light source 5 that is appropriate for nighttime or emergency illumination. Naturally, the illumination level of the illumination apparatus 3 will be set, at the discretion of those skilled in the art, starting from a maximum luminous power by reducing the diode current and the number of driven LEDs 6.

Using LEDs 6 in place of conventional luminaires, such as incandescent lamps or halogen lamps, for example, as a night-light or an emergency light of the extractor hood 1, considerably decreases the power consumption of the illumination apparatus 3 because conventional luminaires have extremely poor efficiency when dimmed to a large extent.

Provision is also made for the light source 5 of the abovementioned embodiments of the illumination apparatus 3 to be connected to an energy store 9 so that the night light or the emergency light of the extractor hood 1 can also be used in the event of a failure of the power supply. The combination of the light source 5 with an energy store 9 in the form of, for example, a rechargeable battery or a capacitor, thus, provides a “real emergency light” for an extractor hood.

Provision is further made for the illumination apparatus 3 to be provided with a control device 10 that determines the failure in the usual power supply. In the event of an activation of the emergency light function of the illumination apparatus 3, the emergency illumination is activated automatically in the event of a failure in the power supply, the emergency illumination being operated using the energy store 9. In particular, such a configuration increases, safety for kitchen staff working in a kitchen where no windows are provided.

The advantages of using LEDs in an extractor hood for the purpose of illuminating the cooktop located beneath the extractor hood are, in particular, the increased freedom in the construction of the extractor hood, an improvement in the illumination of the cooktop, a low power consumption, a long life, and the fact that, because of this, the elimination of lamp replacement operations.

We claim:

1. In an extractor hood, an illumination apparatus comprising:
a light source including a plurality of drivable LEDs.

2. The illumination apparatus according to claim 1, further comprising a control device connected to said LEDs and varying a luminous intensity of said LEDs.

3. The illumination apparatus according to claim 1, further comprising a control device connected to said LEDs and individually driving said LEDs.

4. The illumination apparatus according to claim 2, wherein said control device individually drives said LEDs.

5. The illumination apparatus according to claim 1, wherein said light source has a radiated power set by altering at least one of the group consisting of a diode current and a number of said LEDs driven.

6. The illumination apparatus according to claim 1, wherein said light source is a combination of said LEDs and lamps.

7. The illumination apparatus according to claim 1, wherein said light source includes at least one lamp.

8. The illumination apparatus according to claim 7, further comprising a control device connected to said LEDs and to said lamp and independently controlling said LEDs and said lamp.

9. The illumination apparatus according to claim 1, further comprising an energy store connected to said light source.

10. The illumination apparatus according to claim 9, wherein said energy store is at least one of the group consisting of a rechargeable battery and a capacitor.

11. The illumination apparatus according to claim 9, wherein:
said light source is to be connected to a power supply; and
a control device is connected to said LEDs, said control device detecting a failure in the power supply and thereupon operating at least some of the LEDs with the energy store as an emergency light.

12. The illumination apparatus according to claim 8, wherein:
said light source is to be connected to a power supply; and
said control device detects a failure in the power supply and thereupon operates at least some of the LEDs with the energy store as an emergency light.

13. An illumination apparatus for an extractor hood, comprising:
an extractor hood control device; and
an extractor hood light source having a plurality of LEDs, said extractor hood light source being connected to said control device, said control device varying a luminous intensity of at least some of said LEDs.

14. An illumination apparatus for an extractor hood, comprising:
an extractor hood control device; and
an extractor hood light source having a plurality of LEDs, said extractor hood light source being connected to said control device, said control device programmed to at least one of:
vary a luminous intensity of at least some of said LEDs;
altering a diode current of at least some of said LEDs; and
drive a subset of said LEDs.

15. An illumination apparatus for an extractor hood, comprising:
an extractor hood control device;
an extractor hood light source connected to said extractor hood control device; and having:
at least one lamp; and
a plurality of LEDs; and
said control device varying a luminous intensity of at least some of said LEDs.

16. An illumination apparatus for an extractor hood, comprising:
an extractor hood control device;
an extractor hood light source connected to said control device and having:
at least one lamp; and
a plurality of LEDs; and
said control device programmed to at least one of:
vary a luminous intensity of at least some of said LEDs and said lamp;
altering a diode current of at least some of said LEDs;
drive a subset of said LEDs and said lamp; and
independently control said LEDs and said lamp.
